(19) United States
(12) Patent Application Publication
(10) Pub. No.: US 2015/0062344 A1
(43) Pub. Date: Mar. 5, 2015

(54) Monitoring Camera Device and Monitoring Camera System

(71) Applicant: Hitachi Industry & Control Solutions, Ltd., Hitachi-shi (JP)

(72) Inventors: Satoshi SANO, Tokyo (JP); Mayumi NAKADE, Tokyo (JP); Shinichiro HIROOKA, Tokyo (JP)

(21) Appl. No.: 14/458,342

(22) Filed: Aug. 13, 2014

(30) Foreign Application Priority Data
Aug. 27, 2013 (JP) 2013-175141

(51) Int. Cl. H04N 5/775; G11B 20/00; H04N 7/18

(52) U.S. Cl. CPC H04N 5/775; H04N 7/183; H04N 7/181; G11B 20/00007
USPC 348/159; 348/143

(57) ABSTRACT

There is provided a monitoring camera device including: an image taking section that performs photoelectrical conversion on a received light and generates an image signal; a picture processing section that generates picture data created by performing compression coding on the picture signal obtained by the image taking section; a communication processing section that receives and transmits data from and to equipment connected via a network; and a control section, the control section holding camera management information including information on the operational state of a self-owned device and a recording device used as a destination of picture data to record, recording device management information including information on a recording device connected to the network, and recorded content management information on recorded contents of picture data of the self-owned device, and controlling transmission of the recording device management information and recorded content management information with a predetermined timing and switching a recording device to be used as a recorded destination of the picture data based on the recording device management information.

### CROSS-REFERENCE TO RELATED APPLICATION

This is application claims the priority of Japanese Patent Application No. 2013-175141 filed Aug. 27, 2013, which is incorporated herein by reference in its entirety.

### BACKGROUND OF THE INVENTION

1. Field of the Invention

The present invention relates to monitoring camera devices and monitoring camera systems.

2. Description of the Related Art

Among monitoring camera systems proposed is a monitoring camera system that includes a plurality of monitoring cameras and a plurality of recording devices connected to a network, as disclosed in JP 2008-098884 A. Specifically, the above patent publication discloses “a monitoring camera system including: at least two monitoring camera terminals that perform compression coding on an image taken by a camera section and transmit the taken image to a network; and at least two monitored picture recording devices that receive picture data from the monitoring camera terminals via the network and record the picture data, the monitoring camera terminals each having at least two types of compression coding units of a low-resolution compression coding unit with a small number of pixels and a high-resolution compression coding unit with a large number of pixels, and the monitored picture recording devices each having a camera management table indicating a connection state of the monitoring camera terminals, a processing capacity table indicating the processing capacity of the body of the monitored picture recording device, and a recording device management table indicating a connection state of another monitored picture recording device, in which when at least one of the monitoring camera terminals needs to record dynamic image picture using the high-resolution compression coding unit, the monitored picture recording devices confirm the camera management table and the processing capacity table, select, if necessary, at least one of the monitoring camera terminals other than the monitoring camera terminal which needs to record the dynamic image picture using the high-resolution compression coding unit, and request another monitored picture recording device indicated in the recording device management table to record the dynamic image picture of the monitoring camera terminal in place of the monitoring camera terminal.”

### SUMMARY OF THE INVENTION

A monitoring camera system that includes a plurality of monitoring camera devices and a plurality of recording devices requires a proper management of the correspondence relation between the monitoring camera devices and the recording devices used by the monitoring camera devices for recording pictures. Specifically, if a shortage of capacity occurs in a recording device while a monitoring camera device is recording picture data into the recording device and this shortage prevents the recording of the picture data from continuing or if a malfunction occurs in a recording device and this prevents recording of picture data from continuing, a destination to which the picture data is to be recorded (hereinafter referred to as a picture recorded destination, a destination of picture data to record, etc.) needs to be switched from the recording device with the capacity shortage or the malfunctioning recording device to another applicable recording device.

JP 2008-098884 A discloses a picture recording device that manages information on a monitoring camera connected to a network and on picture recording devices other than the self-owned device. The picture recording device according to the above patent publication switches a picture recorded destination based on the information if necessary. This manner of switching a picture recorded destination, however, has much room for improvement, because it is disadvantageous in that each recording device needs to be provided with the function as a management server managing connection equipment and therefore a network-connected general storage unit having been rapidly spreading over these few years, such as a NAS (network attached storage), is not applicable as the recording device.

In view of the above disadvantage, an object of the present invention is to provide a monitoring camera device and a monitoring camera system that are preferable for the monitoring camera device to select a recording device to store picture data without using a management server managing the entire connection equipment in an integral manner.

In order to achieve the above object, the present invention has been made as recited in the claims.

According to the present invention, a monitoring camera system is formed of a plurality of monitoring camera devices and recording devices, and the monitoring camera devices and the monitoring camera system are preferable for selecting a recording device to store picture data without using a management server managing the entire connection equipment in an integral manner.

### BRIEF DESCRIPTION OF THE DRAWINGS

FIG. 1 is a system configuration diagram illustrating an example of a monitoring camera system;

FIG. 2 is a system configuration diagram illustrating an example of a monitoring camera system;

FIG. 3 is a functional configuration diagram illustrating an example of a monitoring camera device;

FIG. 4 is a table illustrating an example of camera managing information;

FIG. 5 is a table illustrating an example of recording device management information;

FIG. 6 is a table illustrating an example of recording device error information;

FIG. 7 is a table illustrating an example of a connection equipment list included in the recording device management information;

FIG. 8 is a table illustrating an example of error information included in the recording device management information;

FIG. 9 is a table illustrating an example of recorded content management information;

FIG. 10 is a flow chart illustrating an example of the operations of a monitoring camera device;

FIG. 11 is a flow chart illustrating an example of updating processing on the recording device management information; and

FIG. 12 is graphs each illustrating an example of a function for weight calculation used for determining a priority of a recording device.

### DESCRIPTION OF THE PREFERRED EMBODIMENTS

An embodiment of the present invention will be hereinafter described with reference to the drawings.

### <System Configuration 1>

FIG. 1 is a system configuration diagram illustrating a monitoring camera system according to an embodiment.

A plurality of monitoring camera devices 101 (monitoring camera devices A to N) and a plurality of recording devices 102 (recording devices A to X) are connected to a network. One-to-one correspondence is not always necessary between the monitoring camera devices 101 and the recording devices 102, and more than one monitoring camera device 101 may perform picture recording on one recording device 102. Each device has its unique ID in the system. The “unique ID” herein may include an IP address and a MAC address usually used in an IP network.

In the configuration, each monitoring camera device 101 not only allows captured picture data to be recorded into a recording device but also broadcast-transmits, to the network, camera management information 305 formed of information on a self-owned device and a recording device 102 used by the self-owned device for recording pictures. The “self-owned device” herein is the monitoring camera device 101 itself. In a case of the monitoring camera device A, for example, the monitoring camera device A is the “self-owned device” and the monitoring camera devices B to N are each “another monitoring camera device”.

A monitoring camera device 101 calculates recording device management information 306 formed of the operational state of a recording device 102 connected to the network, based on the camera management information 305 transmitted from another monitoring camera device 101, and holds the calculated recording device management information 306.

If a malfunction occurs in a recording device 102 that a monitoring camera device 101 is using as a picture recorded destination and this prevents the recording of picture data from continuing, the monitoring camera device 101 selects a desirable recording device 102 as a new picture recorded destination for the self-owned device, using the recording device management information 306, and switches the picture recorded destination from the malfunctioning recording device 102 to the selected recording device 102.

For example, if the monitoring camera device A is recording picture data into the recording device A and the remaining capacity of the recording device A becomes lower than a predetermined level, the monitoring camera device A can select a recording device 102 with a large remaining capacity based on the recording device management information 306 held by the monitoring camera device A and change the picture recorded destination to the selected recording device 102. Further, if the monitoring camera device A is recording picture data into the recording device A and a writing error occurs with a frequency greater than a predetermined level, the monitoring camera device A can select a recording device 102 with a lowest frequency of error occurrence based on the recording device management information 306 held by the monitoring camera device A and change the picture recorded destination to the selected recording device 102. It is to be noted that although only one item such as a remaining capacity or an error occurrence frequency is considered to determine a new recorded destination in the embodiment, the determination may be made based on a combination of a remaining capacity, an error occurrence frequency, a total bit rate of picture data to be input into a recording device 102, etc. . . .

### <Configuration and Processing of Monitoring Camera Device>

The monitoring camera devices 101 will be described in detail.

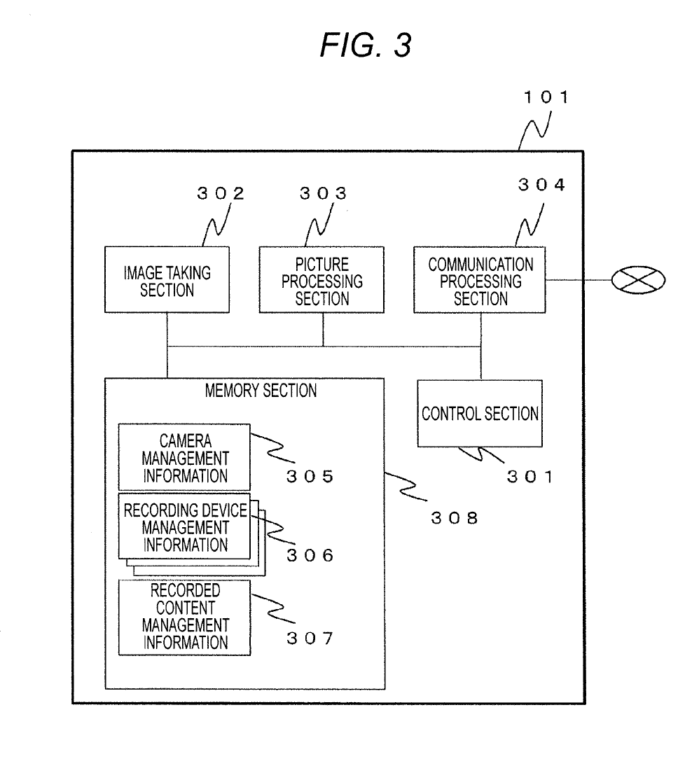

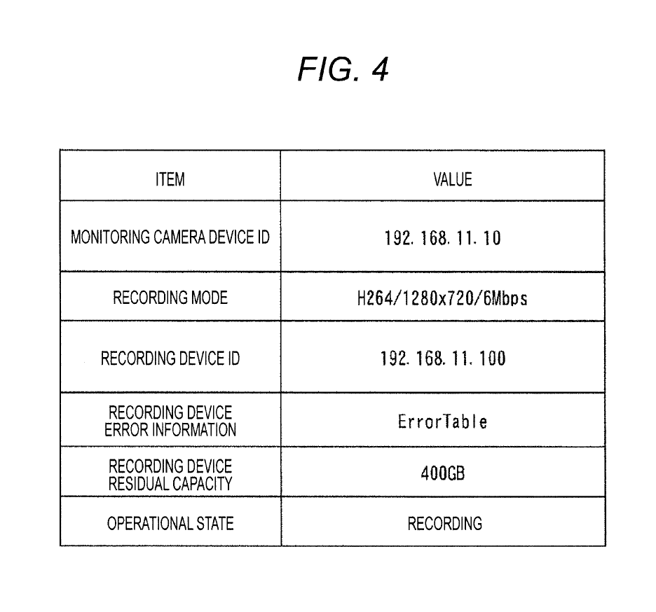

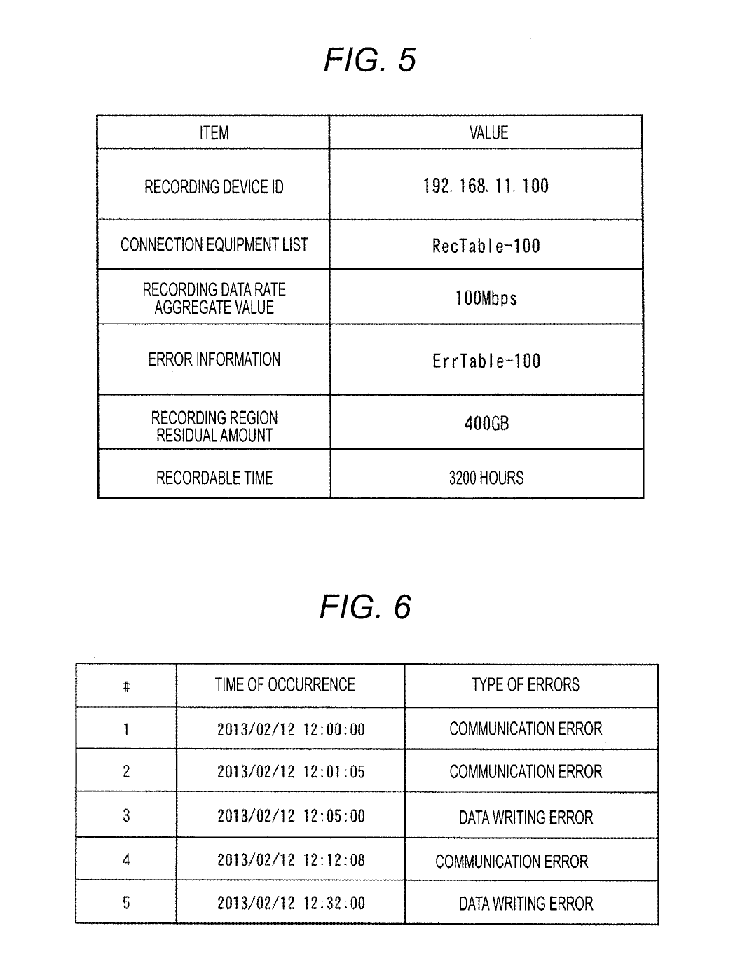

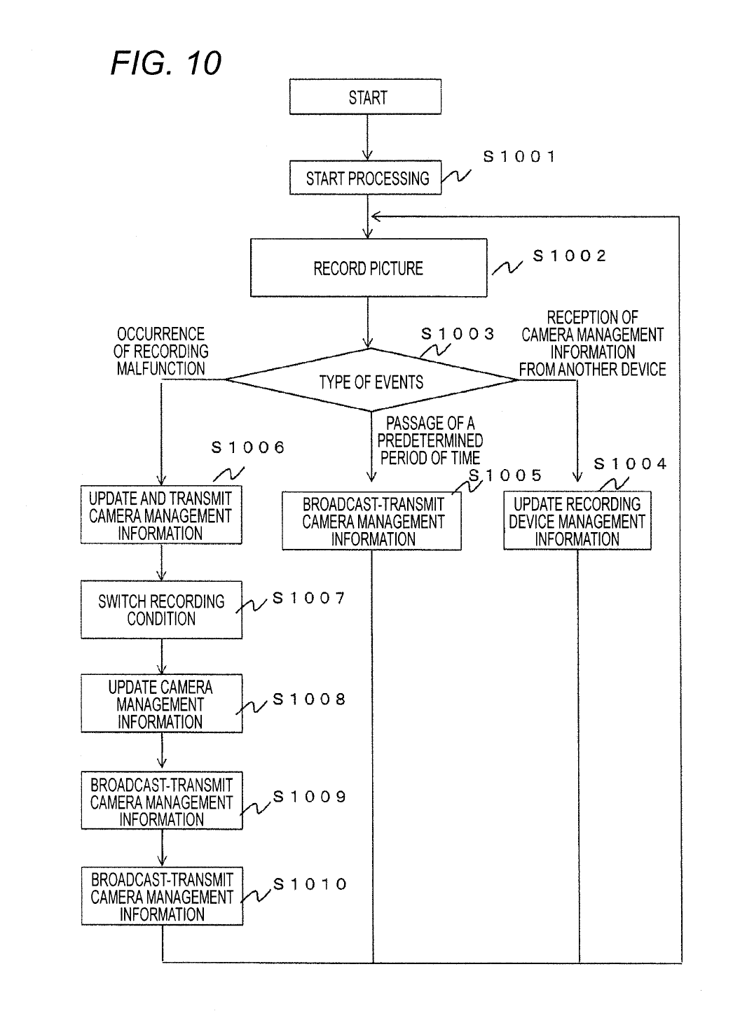

FIG. 3 is a functional configuration diagram illustrating a monitoring camera device 101. The monitoring camera device 101 includes: an image taking section 302 that performs photoelectrical conversion on a received light and generates an image signal; a picture processing section 303 that generates picture data created by performing compression coding on the picture signal obtained by the image taking section 302; a communication processing section 304 that receives and transmits data from and to equipment connected via a network; a memory section 308 that holds camera management information 305 formed of information on the operational state of the self-owned device and on a recording device used as a picture recorded destination, recording device management information 306 formed of information on a recording device connected to the network, and recorded content management information 307 on recorded contents of picture information of the self-owned device; and a control section 301 that controls transmission of the camera management information 305 with a predetermined timing and switches a recording device used as a destination to record the picture data based on the recording device management information 306. The camera management information 305 and the recording device management information 306 will be described first with reference to FIGS. 4 and 5. Subsequently, the flow of processing by the monitoring camera device 101 and the processing by the components will be described with reference to FIG. 10.

### <Camera Management Information>

The camera management information 305 and the recording device management information 306 will be described first.

FIG. 4 is a drawing illustrating an example of the camera management information 305. The camera management information 305 is formed of information on the operations of a self-owned device and on a recording device 102 used by the self-owned device as a destination to record picture data.

Monitoring camera device ID is unique ID assigned to a self-owned device in the system. A recording mode is the format of picture data that a self-owned device transmits to a recording device 102, and is managed as a combination of items including a picture resolution, a picture data bit rate, a picture data compression method, etc. Recording device ID is ID unique to a recording device 102 that a self-owned device is using to record picture data. Recording device error information is information on errors that occurred when a self-owned device was recording pictures into a recording device 102 being used. Specifically, the error information includes the number and the time of error occurrence, and the types of errors, as shown in FIG. 6. A recording device residual amount is a usable residual storage capacity of a recording device 102 that a self-owned device is using, and can be acquired from the recording device 102 with a general control protocol. The operation state of a self-owned device indicates whether the self-owned device is recording picture data into a recording device 102 or has stopped recording. The operation state is varied according to cases, the cases including ones where a combination of picture recording and interruption of the picture recording is performed at predetermined intervals, where picture data is recorded for a specified period of time and is not recorded for the other period of time, and where pictures are recorded only if a monitoring camera device satisfies a specific condition.

### <Recording Device Management Information>

FIG. 5 is a drawing illustrating an example of the recording device management information 306. The monitoring camera devices 101 hold the recording device management information 306 for the recording devices 102 connected to the monitoring camera system. Recording device ID is unique ID assigned to each of the recording devices 102 in the system. A connection equipment list is a list of ID and recording modes of monitoring camera devices 101 (FIG. 1) using recording devices 102 (FIG. 1) as destinations to store picture data. The details thereof will be described later. A recording data rate aggregate value is an amount per unit time of picture data received from monitoring camera devices 101, in a case where at least two monitoring camera devices 101 are recording picture data into a recording device 102. The recording data rate aggregate value is used for determining a data reception load or a data writing load of a recording device 102. The error information is collected pieces of information on the errors having occurred in a recording device 102, and is used for judging the reliability of the recording device 102. The details thereof will be described later. A recording region residual amount is a usable remaining storage capacity for recording picture data. A recordable time is a time for which pictures can be recorded if a current recording data rate continues being used.

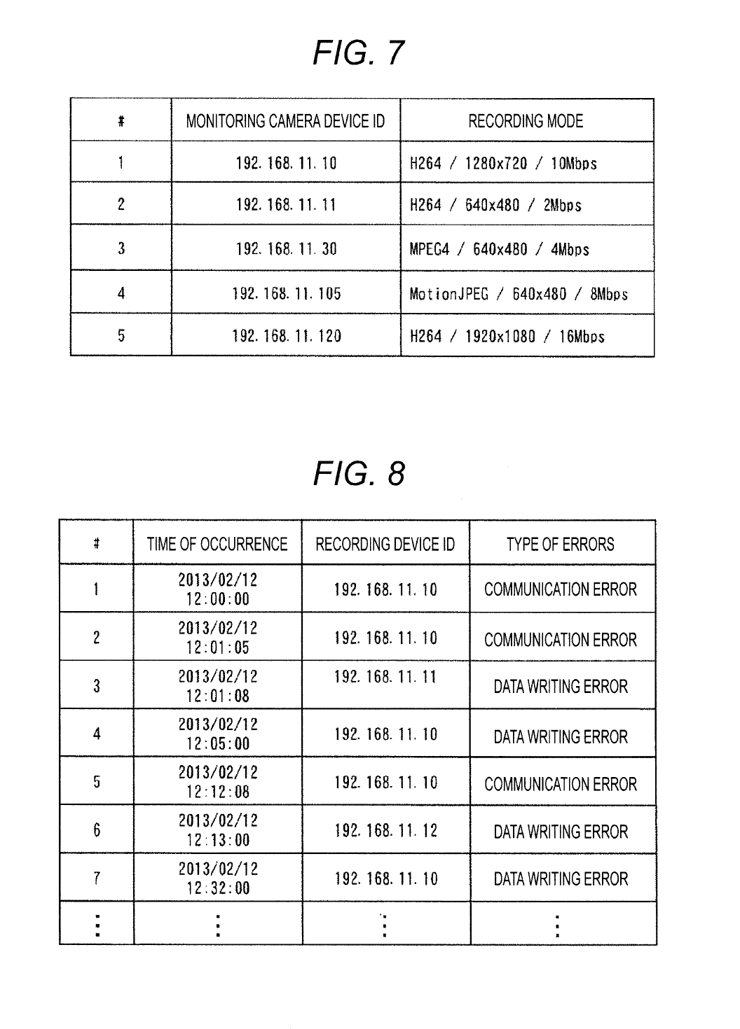

FIG. 7 is a drawing illustrating an example of the connection equipment list held in the recording device management information 306. The list holds unique ID and recording modes of monitoring camera devices 101 using, as destinations of picture data to record, the recording devices 102 for the recording device ID in the recording device management information 306. The recording modes correspond to the modes included in the camera management information 305.

FIG. 8 is an example of error information held in the recording device management information 306. The error information holds a list of unique ID of monitoring camera devices 101 using, as destinations of picture data to record, the recording devices 102 for the recording device ID in the recording device management information 306, the types of errors having occurred in the processing of recording picture data into the recording devices, and the times of occurrence of the errors. The times of occurrence of errors and the types of errors correspond to recording device error information included in the camera management information 305.

Since the recording device management information 306 includes the recording data rate aggregate value as described above, a monitoring camera device can select a recording device on which writing of data is not highly focused, in switching a recording device to be used as a destination of picture data to record. Further, the error information enables selection of a recording device with a low frequency or number of error occurrence. Moreover, the recording region residual amount and the recordable time included make it possible to select a recording device capable of recording picture data for a long period of time. In addition, a combination of the above items achieves selection of a recording device to replace a previous recording device.

FIG. 10 is a drawing illustrating a flow of processing by a monitoring camera device 101. With reference to the flow, descriptions will be made on the operations of a monitoring camera device 101 and the processing by each component.

When a monitoring camera device 101 (FIG. 3) is started, S1001 executes processing for starting hardware or software, and the step proceeds to S1002 after completion of S1001 so that a picture recording operation is started.

In S1002, the control section 301 issues an instruction to the picture processing section 303 (FIG. 3) based on the information on the screen resolution, the bit rate, the compression coding method, etc. set in a recording mode of the camera management information 305 (FIG. 3). The picture processing section 303 performs, in response to the instruction from the control section 301, processing of compressing a picture signal fetched by the image taking section 302 including a lens, an image taking element, and a light exposure control unit, into picture data in a format for being stored in a recording device 102. In addition, the control section 301 issues an instruction to the communication processing section 304 to record picture data into a recording device 102.

The control processing section 304 carries out, in accordance with the instruction from the control section 301, communication processing including command control on the recording device 102 and transmission of picture data to the recording device 102, in order to record into the recording device 102 picture data that the picture processing section 303 stores in the memory for the recording device 102. The processing can be realized by using a widely released control method such as NFS (network file system) or CIFS (common internet file system). These control methods are only exemplary and other methods may be employed for the recording processing. The control section 301 notifies the communication processing section 304 (FIG. 3) of recording device ID held in the camera management information 305 (FIG. 3) as information on a picture recorded destination, in issuing the above request to the communication processing section 304. Further, the communication processing section 304 receives the information notified and communicates with the recording device 102 based on the information.

If the control section 301 detects an event having occurred during the operation for recording picture data, S1003 performs processing appropriate to the event. If the event is a reception of the camera management information 305 (FIG. 3) from another monitoring camera device 101 (FIG. 3), the step proceeds to S1004. If the event is the passage of a predetermined amount of time since the transmission of the management information on a self-owned device, the step proceeds to S1005. Further, if the event is occurrence of an abnormality relating to the picture data recording operation, the step proceeds to S1006.

Allowing the control section 301 to change its processing depending on an event detected during the recording operation as described above makes it possible to broadcast-transmit the camera management information on the self-owned device to the network with an appropriate timing, to change a recording device 102 for recording picture data, and to update the recording device management information 306 held by the self-owned device.

<Updating of Recording Device Management Information by Receiving Camera Management Information from Another Device>

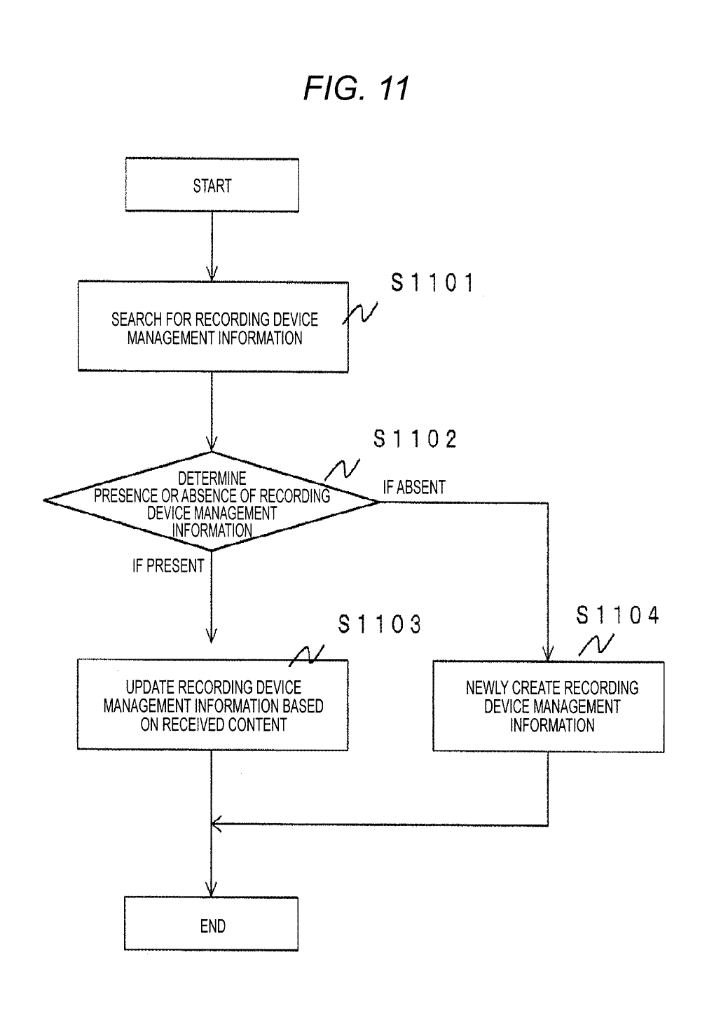

In S1004, the monitoring camera device 101, which has received the camera management information 305 broadcast-transmitted from another monitoring camera device 101, updates the recording device management information 306 held by the self-owned device. The updating processing will be described with reference to FIG. 11.

FIG. 11 is a flow chart illustrating the flow of the updating processing on the recording device management information 306 and will be referred to in the following description.

In S1101, the control section 301 confirms whether or not it holds the recording device management information 306 for the recording device ID set in the received camera management information 305. Further, in S1102, the control section 301 conducts dividing processing according to the presence or absence of the recording device management information 306. Subsequently, the step proceeds to S1103 if the self-owned device holds the recording device management information 306 for the recording device ID, where the connection equipment list, the recording data rate aggregate value, the error information, the recording region residual amount, and the recordable time will be updated based on the received camera management information 305. On the other hand, the step proceeds to S1104 if the self-owned device does not hold the recording device management information 306 for the recording device ID indicated in the received camera management information 305, where recording device management information 306 will be prepared for the recording device ID indicated in the camera management information 305 and the content of each item of the prepared recording device management information 306 will be set based on the value of each region of the received camera management information 305. Thereafter, the step goes back to S1002 in FIG. 10 and the picture recording operation will be continued.

Updating the recording device management information 306 held by the self-owned device every time the monitoring camera device 101 receives the camera management information 305 from another monitoring camera device 101, as described above makes it possible to update the information on the recording device 102 connected to the network to the latest one.

<Transmission of Camera Management Information after Passage of a Predetermined Period of Time>

In S1005, the control section 301 of the monitoring camera device 101 issues an instruction to the communication processing section 304 to broadcast-transmit the camera management information 305 on the self-owned device to the network after the passage of a predetermined time, and the communication processing section 304 broadcast-transmits the camera management information 305 to the network in accordance with the instruction. Thereafter, the step goes back to S1002 and the picture recording operation will be continued.

It is to be noted that the operation in S1005 may be started not only responding to the passage of a predetermined period of time since transmission of the camera management information 305 but also responding to an action of issuing a request to transmit the camera management information to a monitoring camera device 101 by external equipment connected to the network, an action of operating a button provided to a monitoring camera device 101, or an action of performing an operation by a user, for example. Alternatively, the processing in S1005 may be started responding to a change in the state of the self-owned device between starting, termination, interrupting, etc. of recording.

It becomes possible to update the recording device management information 306 held by each monitoring camera device 101 to the latest one, in a manner such that a monitoring camera device 101 periodically transmits the camera management information 305 to the network and another monitoring camera device 101 receives the transmitted camera management information 305 and updates the recording device management information 306 held by its self-owned device, as described above.

Further, allowing the camera management information 305 to be transmitted in respond to a request from the external equipment, as described above enables a newly connected monitoring camera device 101 to collect the camera management information of a monitoring camera device connected to the network without waiting for a predetermined cycle to pass. Moreover, it also becomes easier to acquire the operational state of each monitoring camera device 101 when maintenance work is to be done on the entire system, for example.

### <Processing at Malfunction Occurrence>

The step proceeds to S1006 if a malfunction occurs in picture data recording processing on a recording device 102. The malfunction in this context means a network communication failure or a data writing error of a recording device 102. Further, the same processing as that at the malfunction occurrence can be conducted when the residual capacity of a recording device 102 becomes lower than a predetermined level, for example.

The control section 301 updates the recording device error information on the camera management information 305, and instructs the communication processing section 304 to broadcast-transmit the contents of the updated error information to the network in S1006, and then proceeds to S1007.

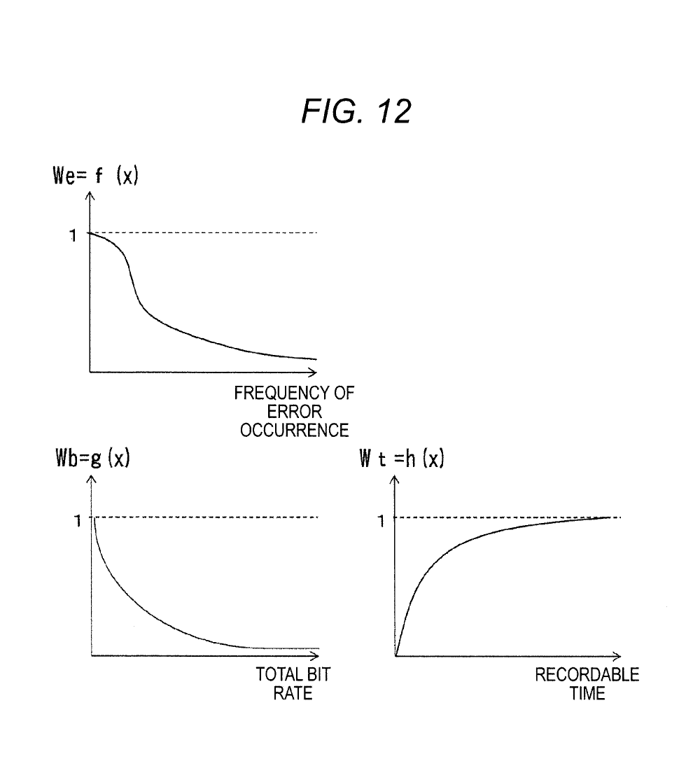

In S1007, the control section 301 selects a recording device 102 to replace the recording device 102 that has become unusable due to the malfunction. Note that the replacement of a recording device 102 is not always necessary for continuing recording pictures in a case where malfunctions occur with a frequency lower than a predetermined level. The control section 301 calculates a priority P for each recording device 102, using the corresponding recording device management information 306 held by the self-owned device. Calculation of the priority P uses a weight We obtained from the error information, a weight Wb obtained from a total bit rate for a recording device 102, and a weight Wt obtained from a total bit rate for the residual capacity and picture storage of a recording device 102. We, Wb, and Wt are calculated by Formula (1) to Formula (3) shown below, using functions f(x), g(x), and h(x) indicated in FIG. 12, although the indicated functions are only exemplary and an absolute agreement with the embodiment is not required. Using the thus obtained functions We, Wb, and Wt, the priority P is calculated by Formula (4). α, β, γ in Formula (4) are predetermined constants. For example, if β and γ are set to 0, it is possible to perform control of calculating the priority based on the error information alone.

We=f (error occurrence frequency over the last fixed period) Formula (1)

Wb=g (total bit rate) Formula (2)

Wt=h (recording residual capacity/total bit rate) Formula (3)

P=α×We+β×Wb+γ×Wt Formula (4)

After the priorities are calculated based on all of the recording device management information 306 and a recording device 102 with the highest priority P is selected as a recording device 102 to replace the unusable recording device 102, the step proceeds to S1008.

In S1008, the control section 301 updates the recording device ID and the recording device error information in the camera management information 305 on the self-owned device, to the contents of the recording device 102 selected in S1007, and broadcast-transmits the camera management information 305 updated in S1009 to the network.

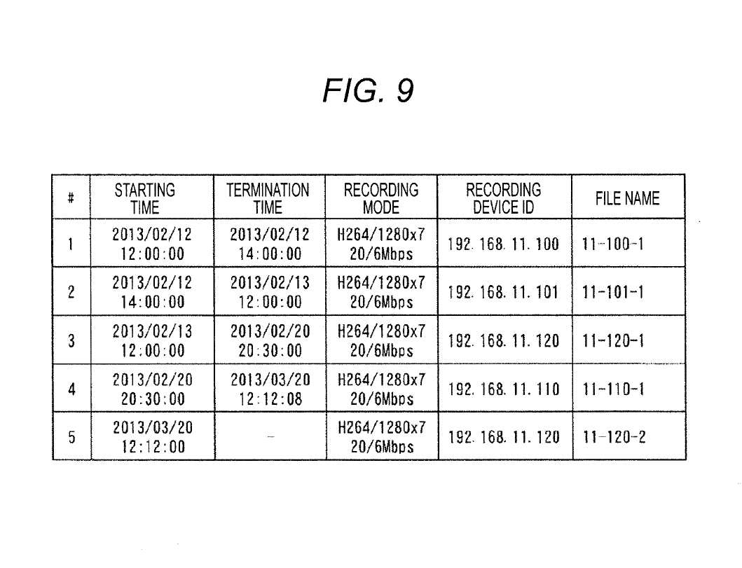

In 51010, a termination time is added to the items of picture data having been recorded in the recorded content management information 307 for managing the correspondence relations between the times when pieces of picture data are recorded and the recording devices 102 storing the picture data, and a starting time of recording new information and ID of a recording device 102 to store the newly recorded information are set. Thereafter, the step goes back to S1002 and the picture recording operation will be resumed. FIG. 9 shows an example of the recorded content management information.

In the meanwhile, if multiple malfunctions sequentially occur over a short period of time, more than one malfunctions which occur over a period of time set in advance may be grouped together as one malfunction in executing the processing, instead of executing the processing in from S1006 to 51010 for every occurrence of a malfunction. The processing thus executed achieves prevention of an increase in a network traffic or in a processing load of a monitoring camera device 101.

With the processing described above, it becomes possible that a monitoring camera device 101 holds information on the operations of a recording device 102 connected to the network and responds to the necessity of switching a recording device 102 by selecting a desirable recording device 102 for storing picture data and replacing a malfunctioning recording device 102 with the selected recording device 102 even in an environment that there is no management server managing the entire monitoring camera system in an integrated manner.

### <System Configuration 2>

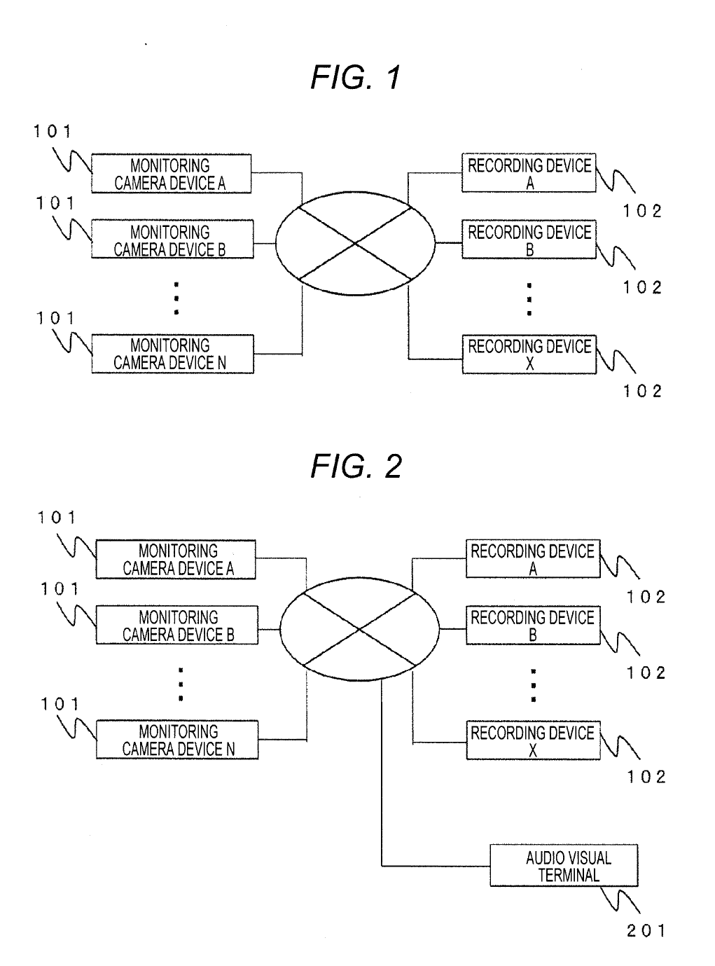

Descriptions will be made next with reference to the drawings on a method of viewing a recorded picture in the monitoring camera system according to the embodiment. FIG. 2 is a drawing illustrating an audio visual terminal used for viewing pictures, connected to the monitoring camera system. The monitoring camera devices 101 and the recording devices 102 in FIG. 2 are equivalent to those in FIG. 1. The audio visual terminal 201 may be connected with the network constantly or only while recorded picture data needs to be checked.

The audio visual terminal 201 requests a monitoring camera device 101 which has taken an image of picture data to acquire the recorded content management information 307. The monitoring camera device 101 receives the request from the audio visual terminal 201 and then transmits the contents of the recorded content management information 307 to the audio visual terminal 201. Examples of a method for acquiring the recorded content management information from the monitoring camera device 101 include a unique communication control method, and a method of providing the monitoring camera device 101 with a function of a web server or a file server and allowing the audio visual terminal 201 to access a predetermined network address of the monitoring camera device 101.

The audio visual terminal 201 having acquired the recorded content management information 307 from the monitoring camera device 101 reads recorded picture data from the recording device 102. In so doing, the audio visual terminal 201 can read data through a direct communication with the recording device 102 based on the contents of the acquired recorded content management information 307. Alternatively, the audio visual terminal 201 can request the monitoring camera device 101 to which data has been recorded, to transmit the recorded picture data, so that the monitoring camera device 101 can read the requested data from the recording device 102 and transmit the read picture data to the audio visual terminal 201.

The processing described above enables viewing of picture data when the audio visual terminal 201 is not compatible with a method for communicating with a recording device 102 but is compatible with a method for communicating with a monitoring camera device 101.

Alternatively, pictures captured by the camera can be viewed at a desired time, not in a manner such that the audio visual terminal 201 acquires recorded content management information from the monitoring camera device 101 but in a manner such that the audio visual terminal 201 specifies time information in picture data to be viewed, determines which one of the recording devices 102 stores the picture data as a viewing target, using the specified time information and the recorded content management information 307 held by the self-owned device, reads the picture data from the determined recording device 102, and transmits the picture data to the audio visual terminal 201.

Further, when the monitoring camera device 101 is holding the recorded content management information 307 in an increased data amount, it is possible to allow the recorded content management information 307 to be saved in a server, for example, prepared in advance at the outside, or to shift data to a recording medium such as an SD card connected to the monitoring camera device 101 by a service-man. The shifting of the recorded content management information 307 is not always carried out responding only to an increase in the data amount but is carried out responding to switching of a recording device 102 necessitated by malfunction occurrence or reception of a request from external equipment connected to the network.

Moreover, a recording device 102 may be configured to be able to regenerate picture data recorded in the recording device 102 itself.

With the processing described above, it becomes possible that a desired monitoring camera device 101 views a recorded picture at a desired time without the need of using equipment integrally managing devices connected to the monitoring camera system and of constantly connecting the audio visual terminal to the network.

It should be understood that the present invention is not particularly limited to the embodiment described above and may include various modified examples. Specifically, the embodiment is detailed descriptions of the present invention made for easy understanding of the invention, and the present invention does not necessarily need to include all of the configurations mentioned above. Further, the configurations of one embodiment may be partly replaced by or additionally include a configuration of another embodiment. Moreover, addition, deletion, or replacement by another configuration may occur for part of the configurations of each embodiment.

Moreover, each of the above configurations may be partly or entirely formed of hardware, or may be realized by execution of programs by a processor. In addition, the control lines and information lines shown herein are only ones that are considered essential for the descriptions and are not necessarily all of the lines owned by a product. In practice, almost all of the configurations are connected to one another.

1. A monitoring camera device comprising:
an image taking section that performs photoelectrical conversion on a received light and generates an image signal;
a picture processing section that generates picture data created by performing compression coding on the picture signal obtained by the image taking section;
a communication processing section that receives and transmits data from and to a system connected via a network; and
a control section, wherein
the control section holds camera management information including information on an operational state of a self-owned device and a recording device used as a destination of the picture data to record, recording device management information including information on a recording device connected to the network, and recorded content management information including information on recorded contents of the picture data of the self-owned device, and
the control section further controls transmission of the recording device management information and the recorded content management information with a predetermined timing, and switches a recording device to be used as a destination of the picture data to record based on the recording device management information.

2. The monitoring camera device according to claim 1, wherein the predetermined timing is a predetermined time interval.

3. The monitoring camera device according to claim 1, wherein the predetermined timing is a time when the control section changes its operational state between starting, termination, and interrupting, for example, of recording.

4. The monitoring camera device according to claim 1, wherein the predetermined timing is a time when a recordable time or a usable residual capacity of the recording device being used as a destination of recording picture data of the self-owned device becomes lower than a predetermined value.

5. The monitoring camera device according to claim 1, wherein the predetermined timing is a time when malfunctions are detected with a frequency exceeding a predetermined level within a time period set in advance in picture data recording processing on the recording device.

6. The monitoring camera device according to claim 1, wherein the predetermined timing is a time when a message is received indicative of an intention of requesting an external device connected to the network to transmit camera management information.

7. The monitoring camera device according to claim 1, wherein the control section determines a recording device as a new picture recorded destination based on at least one of information on error occurrence of the recording device, the residual capacity of the recording device, and a data amount of picture to be input into the recording device.

8. The monitoring camera device according to claim 1, wherein the control section receives a request from an audio visual terminal connected to the network and transmits, in response to the request, the recorded content management information including a correspondence relation between a recording time of picture data and the recording device used as a picture recorded destination.

9. The monitoring camera device according to claim 1, wherein the control section reads picture data from the recording device based on the recorded content management information and transmits the read picture data to an audio visual terminal connected to the network, when the control section receives a picture data viewing request from the audio visual terminal.

10. A monitoring camera system comprising:
a plurality of monitoring camera devices according to claim 1, and
a plurality of recording devices that receive via a network picture data transmitted from the monitoring camera devices and record the picture data.
